(19) United States
(12) Patent Application Publication
(10) Pub. No.: US 2014/0376439 A1
(43) Pub. Date: Dec. 25, 2014

(54) METHOD OF REDUCING PAGING LOAD AND MOBILE COMMUNICATION SYSTEM THEREOF

(71) Applicant: Seung Hee YI, Anyang-si (KR)

(72) Inventor: Seung Hee YI, Anyang-si (KR)

(73) Assignee: ERICSSON-LG CO., LTD., Seoul (KR)

(21) Appl. No.: 14/313,011

(22) Filed: Jun. 24, 2014

(30) Foreign Application Priority Data
Jun. 25, 2013 (KR) 10-2013-0073046
Nov. 5, 2013 (KR) 10-2013-0133609

(51) Int. Cl. H04W 68/02; H04L 12/18

(52) U.S. Cl. CPC H04W 68/02; H04L 12/189
USPC 370/312; 370/315

(57) ABSTRACT

A method of reducing a paging load when a base station controller performs paging for a call service to a base station, and a mobile communication system thereof, are disclosed. The method includes: transmitting a paging message from the base station controller to a representative base station for each paging region when traffic occurs to an idle user equipment in an IP network; and relaying the paging message from the representative base station to the other base stations belonging to the same paging region as the representative base station.

### CROSS-REFERENCE TO RELATED APPLICATIONS

The present application claims priority from Korean Patent Application Nos. 10-2013-0073046 and 10-2013-0133609 filed on Jun. 25, 2013 and Nov. 5, 2013, respectively, the entire subject matters of which are incorporated herein by reference.

### TECHNICAL FIELD

The present disclosure relates to reducing a paging load in a mobile communication system and, more particularly, to reducing a paging load when a base station controller (i.e. BSC or MME) performs paging for a call service to a base station (eNB).

### BACKGROUND

With recent rapid advancement of communication, computer networks and semiconductor technologies, a variety of services using wireless communication networks have been offered, while demands of consumers are becoming higher day by day, and global wireless Internet service markets are growing explosively. In conjunction with these trends, services provided by mobile communication systems using wireless communication networks are evolving to offer multimedia communication services for transfer of a variety of data, in addition to voice services.

In recent years, with the boom of smartphones and high demands for data traffic, mobile carriers are putting investment in equipment and technologies while taking into account system loads or impacts in order to accommodate increased data traffic in a variety of ways.

Current wireless data services, such as Code Division Multiple Access (CDMA) 2000, Evolution Data Only (EV-DO), Wideband CDMA (WCDMA), Wireless Local Area Network (WLAN) and so on, are now commercially available. Thus, in recent years, the use of mobile phones and demands for mobile data in homes are constantly increasing. In connection with this trend, there has been proposed a means for offering a mobile communication service using an indoor subminiaturized base station installed to make available access to a mobile communication core network via an indoor broadband network. For example, in the next generation network systems, there has been proposed arranging a number of small multi-cells (femto cells) in a mobile communication network to meet the requirements for a high data transfer rate and stably provide a variety of services, while reducing the cell size. The subminiaturized base station controlling these femto cells is called an indoor base station or femto base station. In this way, the reduction of cell size can increase efficiency of the next generation network systems using a high frequency band, and the use of many small cells is beneficial in terms of increasing the number of frequency reuse. In addition, the service provided by using a number of small multi-cells is advantageous in that it can improve upon a problem of channel deterioration due to electromagnetic wave attenuation, which is produced when one base station covers the entire cell region in conventional services, and a problem due to the impossibility of providing services to users in radio shadow areas. Considering these advantages, a new system is emerging that combines the existing macro cells (cell regions governed by outdoor base stations) with the existing femto cells (cell regions governed by the subminiaturized base station such as indoor base stations, femto base stations or the like).

Long Term Evolution (LTE) is one network that meets the requirements of high data rate, low-latency and packet-optimized radio access for an access network, and has been devised to accommodate high speed rich media, while guaranteeing backwards compatibility for existing 3GPP/non-3GPP access networks. LTE is an All-IP-based network excluding circuit-switched-based communications, and has improved efficiency in terms of network resources by strengthening a Quality of Service (QoS) management function and providing a differentiated QoS for real time services (for example, voice and video communications) and non-real time services (for example, web browsing, store and forward data transfer). In addition, smart antenna technology has been introduced to expand the bandwidth for radio communication.

In an LTE network, when a User Equipment (UE) is in an active state (in a state performing communication, that is, an EMM-Registered/ECM-Connected/RRC-Connected state, hereinafter “UE CONNECTED state”), the position of the UE is detected by the cell unit. In the UE CONNECTED state, where signal connection between the UE, a base station (enhanced-NodeB (“eNB”)), and a base station controller (Mobility Management Entity (“MME”)) is established, the UE position is managed by the cell unit of the eNB.

If there is no flow of packet in a network for a predetermined period of time, the UE may transition into an idle state (a non-busy state, that is, the EMM-Registered/ECM-Idle/RRC-Idle state, hereinafter “UE IDLE state”) for increased efficiency of the radio network. In the LTE network, in order to manage the mobility of the UE in the idle state, hereinafter idle UE, a number of adjacent eNB cells are sectionalized into minimum units that are grouped into one group, which is managed by the Tracking Area (TA) unit. In the UE IDLE state, where signal connection between the UE, the eNB, and the MME is cut, the UE position is managed by the TA unit.

The eNB transmits information of the TA supported by the eNB to the MME at an initial S1-SETUP procedure and the MME generates a TA List (“TAL”) based on this information and transmits the TAL to the UE. Typically, tens of the eNB cells form the same TA (TA Identifier (“TAI”)) and some TAs are grouped into a single group, which is managed by the TA List.

If traffic to the UE (i.e., traffic directed from an IP network to the UE) occurs when the idle UE, where no communication is performed, the MME of the LTE network wakes the UE to receive data from the UE. The “wakening” (also referred to as paging) is performed in the TA unit. The TA List contains a number of TAs, each of which includes tens or more of the eNB cells. Therefore, the MME may transmit a paging message to tens of (e.g., 30 to 40) eNBs to more than 100 eNBs for providing call services for a specified UE.

When the MME performs the paging to the eNB in this manner, the MME operates to generate and transmit the paging message in a point-to-point manner for all eNBs in a paging region using conventional techniques. However, conventional techniques may lead to a problem of increasing the paging load of the MME in a case where the number of the eNBs in the TA is increased (that is, if more eNBs are included in the TA for improvement of paging success rate) or in a case where the frequency by which the MME performs paging to the eNBs is increased (with an increase in the frequency of call services).

### SUMMARY

The present disclosure includes various embodiments, one or more being directed to reducing a paging load when a base station controller performs paging for a call service to a base station.

According to one embodiment of the present disclosure, there is provided a method of reducing a paging load in a mobile communication system, comprising: transmitting a paging message from a base station controller to a representative base station (eNB) for each paging region (TA) when traffic occurs to a user equipment in an idle state; and relaying the paging message from the representative eNB to the other eNBs belonging to the same TA as the representative eNB.

According to another embodiment of the present disclosure, there is provided a mobile communication system including: a base station controller configured to classify base stations (eNBs) into eNBs capable of supporting a Paging Agent (PA) function and legacy eNBs through a setup procedure and to transmit a paging message to a representative base station (eNB) for each paging region (TA) when traffic occurs to a user equipment in an idle state, wherein the representative eNB is configured to relay the paging message to the other eNBs belonging to the same TA as the representative eNB.

### BRIEF DESCRIPTION OF THE DRAWINGS

FIG. 1 is a schematic diagram illustrating an embodiment of a mobile communication network.

FIG. 2 is a schematic diagram illustrating an embodiment of an EPC network.

FIG. 3 is a conceptual view diagram illustrating an embodiment of a tracking area (TA).

FIG. 4A is a diagram of a table showing a representation of a TAI format, according to an embodiment.

FIG. 4B is a diagram of a table showing a representation of a configuration of an IP multicast address, according to an embodiment.

FIG. 5 is a schematic diagram illustrating an embodiment for reduction of a paging load of MME.

FIG. 6 is a diagram illustrating an embodiment of a protocol stack structure for reduction of paging load.

FIG. 7 is a diagram illustrating an embodiment of a paging load reducing method.

### DETAILED DESCRIPTION

This detailed description is provided with reference to the accompanying drawings. One of ordinary skill in the art may realize that the following description is illustrative only and is not in any way limiting. Other embodiments of the present disclosure may readily suggest themselves to such skilled persons having the benefit of this disclosure.

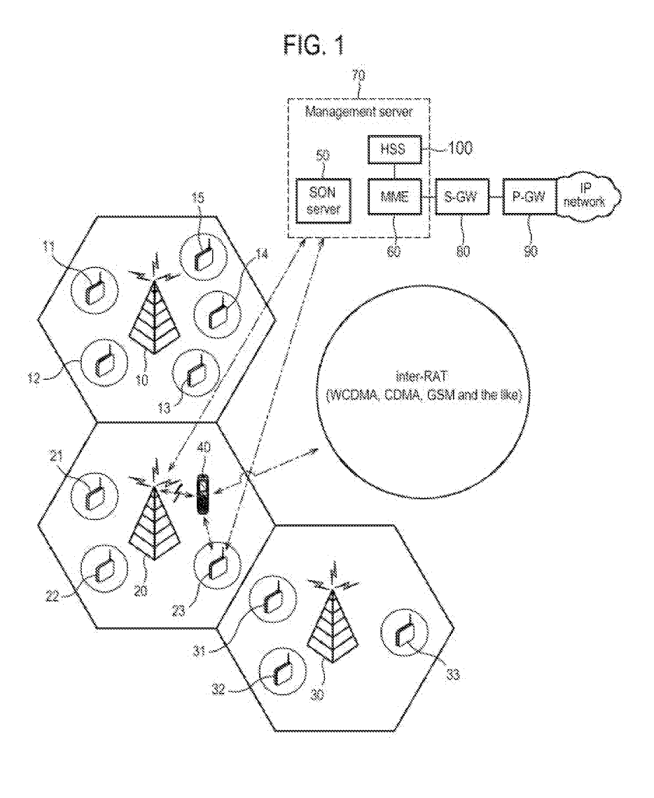

FIG. 1 is a schematic diagram illustrating an embodiment of a mobile communication network.

The mobile communication network of FIG. 1 may include a 2G wireless communication network such as Global System for Mobile communication (GSM) and code division multiple access (CDMA), wireless Internet such as a long term evolution (LTE) network and WiFi, mobile Internet such as Wireless Broadband Internet (WiBro) and World Interoperability for Microwave Access (WiMax), a mobile communication network supporting packet transfers (for example, a 3G mobile communication network such as WCDMA or CDMA2000, a 3.5G mobile communication network such as High Speed Downlink Packet Access (WiMax) or High Speed Uplink Packet Access (HSUPA), a 4G mobile communication network in current service, or the like) and any other mobile communication networks including, but not limited to, components such as a macro base station (such as a macro eNodeB), a subminiaturized base station (such as a Pico eNodeB or a Home-eNodeB) and a user equipment (UE). The following description is given with an emphasis placed on Evolved Universal Terrestrial Radio Access Network (E-UTRAN), which is a wireless access network of LTE.

As shown in FIG. 1, the mobile communication network may be composed of one or more network cells and includes HetNet environments where different kinds of network cells may be mixed in the mobile communication network. The mobile communication network may include subminiaturized base stations (such as Pico eNodeB, Home-eNodeB, relay and the like) 11-15, 21-23 and 31-33 that manage small-scaled network cells (for example, small cells such as pico cells, femto cells and the like), macro base stations 10, 20 and 30 (such as macro eNodeBs) that manage broader cells (for example, macro cells), a user equipment (UE) 40, a Self Organization & Optimizing Network (SON) server 50, a Mobility Management Entity (MME) 60, a Serving Gateway (S-GW) 80, a PDN Gateway (P-GW) 90 and a Home Subscriber Server (HSS) 100. The number of components shown in FIG. 1 is illustrative only. That is, the number of components of the mobile communication network to which the present disclosure can be applied is not limited to that shown in FIG. 1.

The macro base stations 10, 20 and 30 may include features of macrocell base stations to manage cells having a radius of about 1 km, which can be used in LTE, WiFi, WiBro, WiMax, WCDMA, CDMA, UMTS and GSM networks and any other networks, but is not limited thereto.

The subminiaturized base stations 11-15, 21-23 and 31-33 may include features of pico base stations, indoor base stations, femto base stations, or relays to manage cells having a radius of several to tens of meters, which can be used in LTE, WiFi, WiBro, WiMax, WCDMA, CDMA, UMTS and GSM networks and any other networks, but is not limited thereto.

The subminiaturized base stations 11-15, 21-23 and 31-33 and the macro base stations 10, 20 and 30 may include their respective unique accessibility to a core network.

The user equipment (UE) 40 may include mobile terminals which are used in 2G wireless communication networks such as GSM networks and CDMA networks, wireless Internet networks such as LTE networks and WiFi networks, mobile Internet networks such as WiBro networks and WiMax networks, or any other mobile communication networks supporting packet transfer, but is not limited thereto.

A management server (such as an O&M server) 70, which is a network management device of the subminiaturized base station, is responsible for configuration information and management of the subminiaturized base stations 11-15, 21-23 and 31-33 and the macro base stations 10, 20 and 30. The management server 70 can perform all functions of the SON server 50, the MME 60 and the HSS 100. The SON server 50 may include any server that functions to perform installation and optimization of the macro/subminiaturized based stations and provide basic parameters or data required for each base station. The MME 60 may include any entity used to manage mobility and the like of the terminal 40. In addition, the MME 60 can perform the function of a base station controller (BSC) and can further perform resource allocation, call control, handover control, packet processing control and so on for base stations (such as pico eNodeB, Home-eNondeB, macro eNodeB and the like) connected thereto. The HSS 100 is a kind of database for service/authentication for subscribers.

In one embodiment, a single management server 70 can perform all functions of the SON server 50, the MME 60 and the HSS 100; and the SON server 50, the MME 60 and the HSS 100 can manage one or more macro base stations 10, 20 and 30 and one or more subminiaturized base stations 11-15, 21-23 and 31-33.

Although it is assumed that a network cell includes a mixture of macro cells, pico cells and femto cells in the mobile communication network, the network cell may be formed only by macro cells—pico cells or macro cells—femto cells.

In terms of operation, there is a function of limiting access to the subminiaturized base stations 11-15, 21-23 and 31-33 to specified user equipments (subscribers), while typically permitting all terminals to have access to the macro base stations 10, 20 and 30. This operation function is called an access mode or an operation mode. The access mode of the subminiaturized base stations 11-15, 21-23 and 31-33 is divided into a closed access mode, an open access mode and a hybrid access mode depending on which user equipment is offered with services. The closed access mode (also referred to as a CSG closed mode) permits access for only specified subscribers; the open access mode (also referred to as a CSG open mode) permits access for all subscribers without any access permission conditions; and the hybrid access mode may be regarded a compromise between the closed access mode and the open access mode.

In more detail, the subminiaturized base stations 11-15, 21-23 and 31-33 can broadcast system information such as SIB 1 (System Information Block type 1), which contains a Closed Subscriber Group (CSG) indicator indicating whether or not an access to a corresponding femto cell is limited to a region of femto cells managed by these base stations. The SIB 1, which is a message stating that a base station (such as HeNB or macro eNB) broadcasts information on its own cells to all user equipments 40, includes Cell Global Identity (CGI) (an unique cell identifier in the network), CSG indication (a factor indicating the subminiaturized base station), CSG ID (ID for CSG) and so on.

Assuming that the mobile communication network is a LTE network, the LTE network is interlocked with inter-RAT networks (such as WiFi, WiBro, WiMax, WCDMA, CDMA, UMTS, GSM network, or the like). If one (for example, WiBro network) of the inter-RAT networks is the mobile communication network, this network is interlocked with other networks (LTE, WiFi, WiMax, WCDMA, CDMA, UMTS, GSM network, or the like). Although it is shown in FIG. 1 that one network (for example, LTE network) is separated from other networks (WiFi, WiBro, WiMax, WCDMA, CDMA, UMTS and GSM network), it is assumed that the one network overlaps with the other networks.

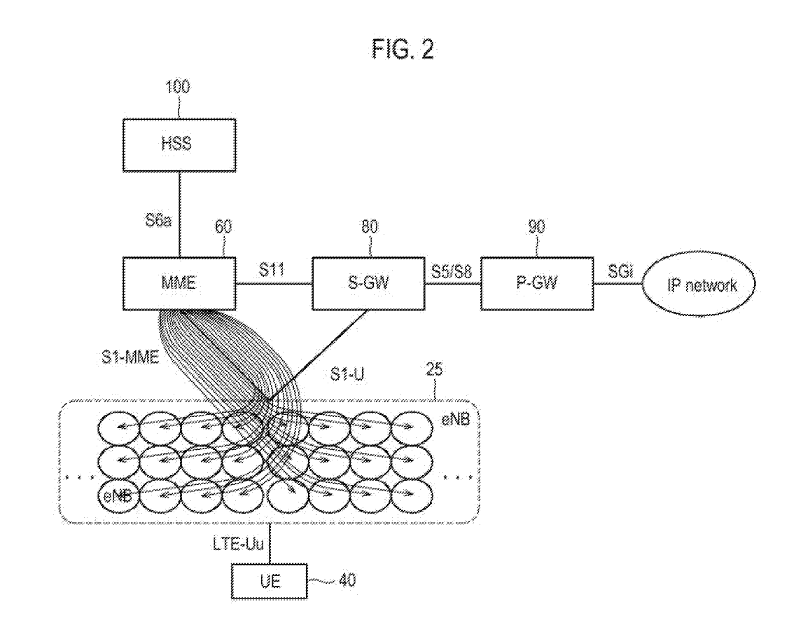

When the subminiaturized base stations 11-15, 21-23 and 31-33 and/or the macro base stations 10, 20 and 30 are collectively named ‘base station,’ E-UTRAN composed of a LTE base station (e.g., eNB 25 in FIG. 2) deals with data traffic between the user equipment 40 and the core network with an IP-based flat structure. The MME 60 is responsible for signal control between the user equipment 40, the base station, and the core network. The MME 60 is also responsible for signal control between the base station (e.g., eNB 25 in FIG. 2) and the S-GW 80 and determines where data input from the UE 40 is routed. The S-GW 80 is responsible for an anchoring function for user equipment's mobility between one base station (e.g., eNB 25 in FIG. 2) and another base station (e.g., another eNB 25 in FIG. 2) and between 3GPP network and E-UTRAN. The UE 40 can access an external or public IP network via the Packet Data Network (PDN) Gateway (P-GW) 90. The MME 60/S-GW 80, which is an equipment of the core network, controls a number of base stations (e.g., eNB 25 in FIG. 2). Each base station (e.g., eNB 25 in FIG. 2) is composed of a number of cells. C-plane/U-plane is controlled between the base station (e.g., eNB 25 in FIG. 2) and the MME 60/S-GW 80 through a S1 interface; and an X2 interface is used to perform the handover and SON function between base stations 25.

Set-up of a network interface is achieved by setting a S1 interface connecting to the MME 60 in the core network and an X2 interface which is network connectivity for direct communication of other cells currently existing on the system with the base station (e.g., eNB 25 in FIG. 2). The S1 interface exchanges a signal, which carries OAM (Operation and Management) information for supporting mobility of the UE 40, with the MME 60. The X2 interface plays a role of exchanging a signal for fast handover, load indicator information and information for self-optimization between base stations 25.

A flow of download data traffic in an EPC (Evolved Packet Core) network will now be described below.

FIG. 2 is a schematic diagram illustrating an embodiment of an EPC network.

The E-UTRAN, which is an IP-based LTE wireless access network composed of base stations (such as eNBs) 25, is located between the UE 40 and a wireless communication core network, and transfers data and control information between the UE 40 and the wireless communication core network. In addition, the E-UTRAN supports paging requests for Circuit Switched (CS) Fallback, a function of transferring a SMS message to the UE 40, a function of providing direct access to a target cell to which a CS-domain service can be offered, or the like.

In FIG. 2, “LTE-Uu” represents a wireless interface between the E-UTRAN and the UE 40; “S1-MME” represents an interface between the E-UTRAN (the base station 25) and the MME 60; “S1-U” represents an interface between the E-UTRAN (the base station 25) and the S-GW 80; “S5/S8” represents an interface between the S-GW 80 and the P-GW 90; and “SGi” represents an interface between the P-GW 90 and the IP network.

The UE 40 communicates with the base station (eNB) 25 of the E-UTRAN via a Radio Resource Control (RRC) protocol and a broadcasting message from the eNB 25 to a cell region controlled by the eNB 25 is defined as a RRC message. The RRC message may include control messages sent from a NAS (Non-Access Stratum) protocol. The NAS messages are transparently delivered to the UE 40 or the core network without being decoded in the E-UTRAN.

The eNB 25 is a termination to a wireless signal of the E-UTRAN; a control signal is interlocked with the MME 60 via the S1-MME interface; and the data traffic is interlocked with the S-GW 80 via the S1-U interface. The S-GW 80 performs an anchor function for mobility in the E-UTRAN and a buffering function for downlink traffic. The P-GW 90 is an external connection point and performs IP allocation and billing for mobile subscribers and a traffic control function for user data.

The data traffic downloaded from the IP network is transmitted through mapping between SGi interface, S5/S8 interface, S1-U interface and LTE-uu interface sections.

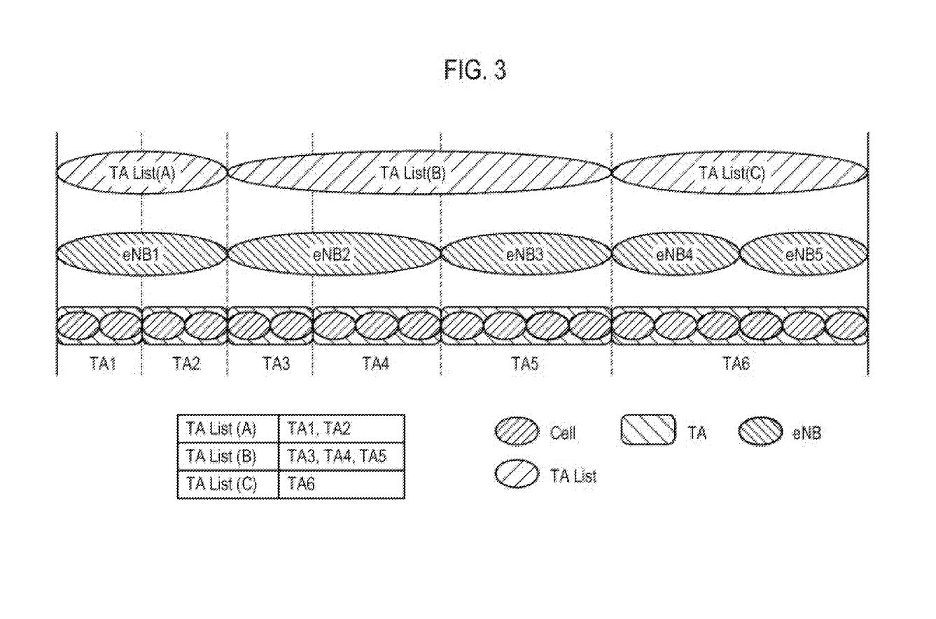

If there is no packet flow for a specific UE 40 in the network during a certain period of time, the UE 40 transitions to an idle state for efficiency in the wireless network. FIG. 3 is a conceptual view diagram illustrating a tracking area (TA), according to an embodiment. As shown in FIG. 3, in order to manage mobility of an idle UE 40 efficiently, the MME 60 sectionalizes adjacent eNB cells with minimum units, and groups the sectionalized adjacent eNB cells into a single group to be managed in the unit of the TA. That is, in the UE IDLE state, where signal connection between the UE 40, the eNB 25 and the MME 60 is cut, the position of the UE 40 is managed in the unit of the TA.

The eNB 25 transmits TA information supported by the eNB 25 to the MME 60 at an initial S1-SETUP; and the MME 60 forms a TA list based on the TA information and transmits the TA list to the eNB 25. The cells of tens of eNBs 25 or more can be assigned the same TA identifier (TAI); and several TAs are grouped into a single group to be managed as a TA list. Mobile carriers bundle some adjacent eNB cells into one group, which may be defined as a single TA. Each TA is initially configured when the network is arranged or constructed. Each eNB is configured in advance to belong to a TA. For example, eNBs located at ‘Samsung-Dong’ may be designated to TA#1; eNBs located at ‘Yeoksam-Dong’ may be designated to TA#2; and eNBs located at ‘Nonhyeon-Dong’ may be designated to TA#3; and so on.

As one example, FIG. 3 shows that TA List (A) consists of TA#1 and TA#2; TA List (B) consists of TA#3, TA#4 and TA#5; and TA List (C) consists of TA#6. The TA List may contain a number of TAs; each of the TAs may include tens of eNB cells or more. That is, tens of eNB cells form the same TA; and several TAs are grouped into a single group to be managed as the TA list. One or a number of eNBs 25 may be configured as one paging group or one tracking area. The management policy of the TA may depend on the service providers.

If traffic occurs to the idle UE 40 from the IP network, the MME 60 wakes the UE 40 so that the UE 40 can receive data traffic, and for this, MME 60 performs a paging procedure by the TA unit in the TA List. If the idle UE 40 is located at ‘Nonhyeon-Dong’ and the MME 60 knows the UE location as TA#3 and wakes the UE 40 to be ready to receive data, in conventional methods, the MME 60 sends a paging message to all eNBs belonging to TA#3 in a point-to-point manner and all eNBs that received the paging message broadcast the paging message to the UE 40 to wake the UE 40. In contrast, according to one or more embodiments of the present disclosure, the paging message may be sent once to a representative eNB one of the eNBs belonging to TA#3 and the representative eNB of the TA#3 section relays the paging message to the other eNBs in a multicasting manner (which is may be referred to as ‘Paging Agent (PA) function’ of the representative eNB). Details of the PA function will be described later.

For the purpose of ease of understanding, a TA format will be described below.

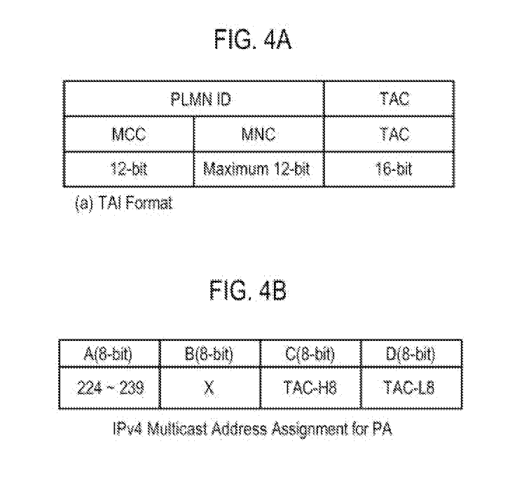

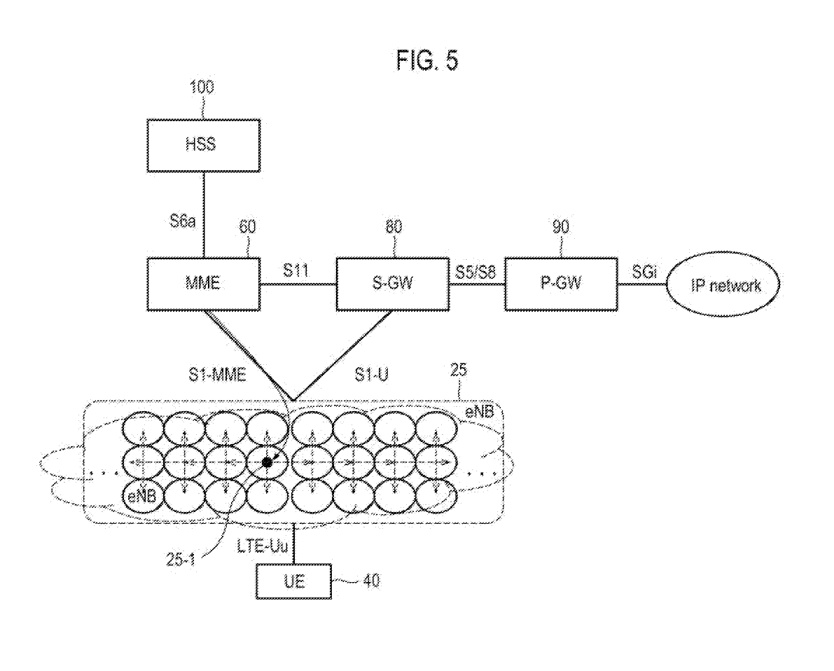

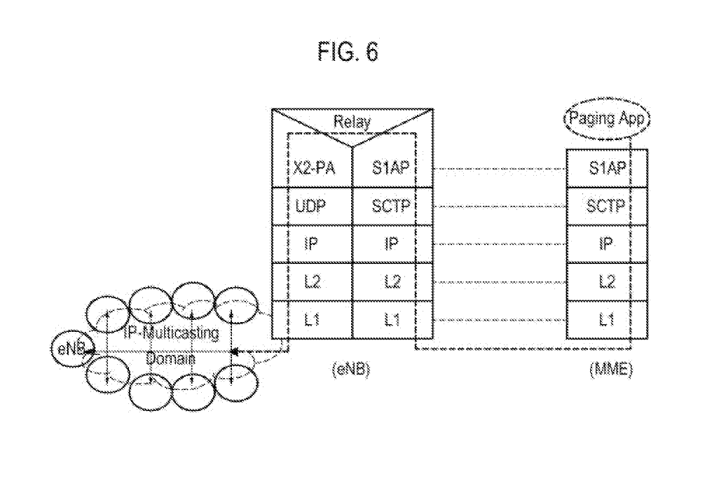

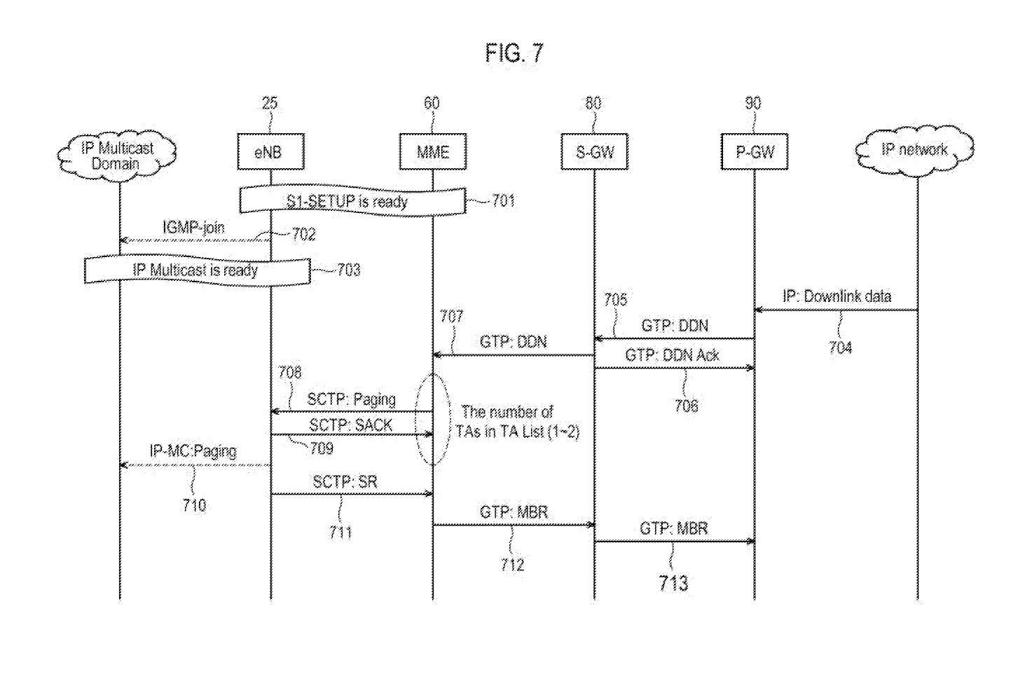

As shown in FIG. 4A, TA, or TAI (TA Identifier), is composed of a “Public Land Mobile Network Identification (PLMN ID)+TAC.” The TAC (TA Code) is a unique value allocated for each TA by mobile carriers (for example, Samsung-Dong TA#1=0x001, Yeoksam-Dong TA#2=0x0002 and Nonhyeon-Dong TA#3=0x0003). The PLMN ID is composed of an “MCC+MNC” and is a unique ID allocated to each of global mobile carriers. For example, Mobile Country Code (MCC) for Korea is allocated as ‘450’ and Mobile Network Code (MNC) for a mobile carrier SKT is allocated as ‘05’. That is, since Korean mobile carrier SKT has MCC=450 and MNC=05, TAI becomes an identifier for allowing SKT to possess its own global unique TA value.

If the TA region is changed due to the mobility of the UE 40, the UE 40 performs a Tracking Area Update (TAU) procedure. For example, the UE 40 existing in an eNB cell zone in the TA#2 region does not perform the TAU when moving within the TA#2 region. However, when the UE 40 moves to an eNB cell zone in the TA#1 region, the UE 40 performs the TAU since the paging group or the tracking area is changed (TA#2→TA#1). Thereafter, when the UE 40 moves within the TA#1, that is, when it moves from one eNB cell zone to another, the UE 40 does not perform the TAU since it has the same paging group or tracking area.

Whenever the TA is changed in this manner, the UE 40 may send a TAU message to the MME 60, which informs the MME 60 of the fact that the TA is changed. However, on the other hand, the UE 40 may perform the TAU in the TA List unit. That is, the UE 40 fetches the TA List when it accesses the network. If the UE 40 fetches and stores the TA List (A) {e.g., TA#1 (TAC1) and TA#2 (TAC2)} as shown in FIG. 3, the UE 40 need not send a TAU Request message to the MME 60 when the UE 40 stays within the TA#1 or TA#2 region and can send the TAU Request message to the MME 60 when the UE 40 moves to a region (e.g., the TA#3) other than the TA#1 or TA#2. Then, the MME 60 sends the UE 40 a response message (TAU Accept message) to the TAU Request message, with the response message carried on a TA List, so that the UE 40 is allowed to update the TA List to meet the mobility of the UE 40. When the idle UE 40 performs the TAU to inform the MME 60 of the UE's position in this manner, the MME 60 creates the TA List consisting of the TAs at which the UE 40 is considered to be positioned in the future by taking into account the TA at which the UE 40 is currently positioned and the mobility of the UE 40, and the MME 60 stores the TA List as location information of the UE 40 (the MME 60 understands the location of the idle UE 40 in the TA List unit consisting of a number of TAs). Thereafter, the MME 60 informs the UE 40 of the TA List; and the UE 40 stores 0e skilled in the art.

What is claimed is:

1. A method of reducing a paging load in a mobile communication system, comprising:
transmitting a paging message from a base station controller to a representative base station (eNB) for each paging region (TA) when traffic occurs to a user equipment in an idle state; and
relaying the paging message from the representative eNB to the other eNBs belonging to the same TA as the representative eNB.

2. The method of claim 1, wherein the relaying the paging message includes relaying the paging message from the representative eNB to the other eNBs belonging to the same TA as the representative eNB in an IP multicasting manner.

3. The method of claim 1, wherein the base station controller classifies the eNBs into eNBs capable of supporting a Paging Agent (PA) function and legacy eNBs through a S1-SETUP procedure and selects an eNB having the smallest load, as the representative eNB, from the eNBs having a paging relay function in the PA function.

4. The method of claim 1, wherein the base station controller classifies the eNBs into eNBs capable of supporting a Paging Agent (PA) function and legacy eNBs through a setup procedure and selects the representative eNB from the eNBs having a paging relay function in the PA function in a round-robin manner whenever the traffic occurs.

5. The method of claim 3, wherein the base station controller further includes a function of transmitting the paging message to the legacy eNBs in a point-to-point manner.

6. The method of claim 3, wherein the PA function includes: a paging relay function of the representative eNB of transmitting the paging message, transmitted from the base station controller, to the other eNBs belonging to the same TA as the representative eNB through an X2 interface in an IP multicasting manner; and an IP multicast receiving function of the other eNBs of receiving the paging message relayed from the representative eNB to an IP multicast address.

7. The method of claim 6, wherein the IP multicast address is configured based on a TA Code (TAC) field information in a TA Identifier (TAI).

8. A mobile communication system comprising:
a base station controller configured to classify base stations (eNBs) into eNBs capable of supporting a Paging Agent (PA) function and legacy eNBs through a setup procedure and to transmit a paging message to a representative base station (eNB) for each paging region (TA) when traffic occurs to a user equipment in an idle state, wherein the representative eNB is configured to relay the paging message to the other eNBs belonging to the same TA as the representative eNB.

9. The mobile communication system of claim 8, wherein the representative eNB relays the paging message to the other eNBs belonging to the same TA as the representative eNB in an IP multicasting manner.

10. The mobile communication system of claim 9, wherein the base station controller selects an eNB having the smallest load, as the representative eNB, from eNBs having a paging relay function in the PA function or selects the representative eNB from the eNBs having a paging relay function in the PA function in a round-robin manner whenever the traffic occurs.

11. The mobile communication system of claim 10, wherein the base station controller further includes a function of transmitting the paging message to the legacy eNBs in a point-to-point manner.

12. The mobile communication system of claim 8, wherein the PA function includes: a paging relay function of the representative eNB of transmitting a paging message, which was transmitted from the base station controller, to the other eNBs belonging to the same TA through an X2 interface in an IP multicasting manner; and an IP multicast receiving function of the other eNBs of receiving the paging message relayed from the representative eNB to an IP multicast address.

13. The mobile communication system of claim 12, wherein the IP multicast address is configured based on a TA Code (TAC) field information in a TA Identifier (TAI).
